(19) United States
(12) Patent Application Publication
(10) Pub. No.: US 2005/0167524 A1
(43) Pub. Date: Aug. 4, 2005

(54) Atomizing nozzle with a rotary annular gap

(76) Inventor: Herbert Huettlin, Lorrach (DE)

Correspondence Address: ST. ONGE STEWARD JOHNSTON & REENS, LLC, 986 BEDFORD STREET, STAMFORD, CT, 06905-5619, US

(21) Appl. No.: 11/037,662

(22) Filed: Jan. 18, 2005

Related U.S. Application Data
(63) Continuation of application No. PCT/EP03/07715, filed on Jul. 16, 2003.

(30) Foreign Application Priority Data
Jul. 16, 2002 (DE) 102 32 863.3

(51) Int. Cl. A62C 5/02

(52) U.S. Cl. 239/222.17

(57) ABSTRACT

An atomizing nozzle has a flow channel of annular cross section for guiding a medium to be atomized, which flow channel is circumscribed by two walls spaced radially apart from one another and opens into an annular nozzle orifice. Furthermore, a second flow channel for guiding a gaseous spray medium is provided, which flow channel encircles the first flow channel and likewise opens into an annular nozzle orifice. It is proposed that the walls circumscribing the first flow channel are rotatable relative to one another about a nozzle longitudinal axis.

### CROSSREFERENCE TO PENDING APPLICATION

This application is a continuation of pending international application PCT/EP 2003/007715 filed on Jul. 16, 2003 which designates the US and which claims priority of German patent application No. 102 32 863.3 filed on Jul. 16, 2002.

### BACKGROUND OF THE INVENTION

The present invention relates to an atomizing nozzle, with a first flow channel of annular cross section for the guidance of a medium to be atomized, which flow channel is circumscribed by two walls spaced radially apart from one another and opens into an annular nozzle orifice, and with a second flow channel for guiding a gaseous spray medium, which flow channel encircles the first flow channel and likewise opens into an annular nozzle orifice.

An atomizing nozzle of this type is known, for example, from DE 197 49 071 A1. Atomizing nozzles of this type serve for spraying a medium to be atomized, usually a liquid, sometimes also a powder, with the aid of a gaseous spray medium.

In this context, the medium to be atomized is transported under pressure through the annular or gap-like flow channel to a nozzle orifice taking the form of an annular gap.

This first annular flow channel is encircled by a second likewise annular flow channel, and the likewise opens into, adjacent to the first flow channel, in an annular or gap-like nozzle orifice.

Depending on how the mouth head of the nozzle is designed, such nozzles spray axially or laterally to a greater or lesser extent away from the axial axis, with an increasingly larger spray angle, in this case with spray angles of up to 180° and with a looping angle of 360° around the mouth head.

Such nozzles are in widespread use in devices for the treatment of particulate material, for. example for the granulation or coating of these particles. In granulation, a tacky liquid is sprayed, which serves for sticking together the particles into larger agglomerates, that is to say the desired granulates.

In coating, a covering layer is sprayed onto the surface.

Such devices are used, above all, in the pharmaceutical industry, where tablet ingredients which are produced as fine-dust powders are granulated into handable powders capable of being pressed, for example, into a tablet.

In coating, pellets or finished granulates or even whole tablets are provided with an outer covering layer.

Depending on the configuration of the device, the nozzles spray vertically upwards, that is to say are designed as upright nozzles, spray at an inclination or are directed horizontally or even, in many instances, vertically from the top downwards.

By means of atomizing nozzles of this type, suspensions, dispersions or solutions can be sprayed, and these can also be employed in what are known as hot-melt methods in which wax melts or hard grease are processed under thermal influence.

In order to achieve as fine a spraying as possible, the annular flow channels operate with liquid cross sections which are in the region <0.25 mm.

In the practical use of such spray nozzles, then, it was found that, with some kind of suspensions or dispersions, partial blockages of the small liquid cross section occur due to undissolved solid fractions.

This can also be observed especially when these solid fractions are of a fibrous or crystalline nature.

Taking the example of the abovementioned nozzle with a spray angle of 180° or a looping angle of 360°, the nozzle head sprays a spray cone in the form of a plane spray pat. If blockages occur then, no medium to be atomized emerges in certain circumferential regions of the annular gap. This has extremely adverse effects on the treatment result which is to be achieved by means of an apparatus in which such an atomizing nozzle is arranged.

In a fluidized-bed coater, for example, the material to be treated is swirled or moved around the nozzle, so that, in a nozzle spraying unequally along the circumference because of blockages, an irregular treatment result is obtained.

However, it is precisely the aim, in this technology, to achieve as uniform a treatment result as possible, for example to obtain granulates within a very narrow grain-size range or covering layers with as equal a covering thickness as possible.

It is object of the present invention to develop further an atomizing nozzle of a type mentioned above to the effect that even medium to be sprayed which tend to cause blockages can be atomized uniformly.

### SUMMARY OF THE INVENTION

This object is achieved, in that the walls circumscribing the first flow channel are rotatable relative to one another about a nozzle longitudinal axis. The relative movement of the two walls to one another can be achieved by rotating only on wall or by rotating both walls either in opposite directions or in the same direction but with different rotating speeds.

It was found that, in such a configuration of the gap-forming walls, a centrifugal and radial, that is to say toroidal movement is established in the annular gap. The medium to be atomized, conveyed through the annular gap in the axial direction, is moreover also set, by the walls rotating relative to one another, in a rotating movement which results in the abovementioned toroidal movement. If, then, media tending to cause blockages or also entraining even smaller solid lumps are guided through such a flow channel, the rotary configuration of the liquid gap results in some comminution of such solid lumps which would otherwise lead to a blockage of the liquid gap in the case of stationary walls. Virtually a kind of self-cleaning effect is achieved by means of the rotary configuration, so that the medium to be atomized ultimately leaves the annular nozzle orifice, uniformly distributed circumferentially.

In a further embodiment of the invention, moreover, the two walls are also axially displaceable relative to one another, with the result that the gap width of the nozzle orifice of the first annular flow channel can be varied.

This measure has the considerable advantage in that it is possible, by virtue of the axial moveability, to vary the gap width of the nozzle orifice of the first flow channel and, in particular, even to close this nozzle orifice. If the nozzle is not in use or is temporarily not in use, the nozzle orifice is closed, so that no dirt enters or no blockages occur due to drying-out or the like in the region of the nozzle orifice.

An essential and considerable advantage of this axial displaceability is also that a self-regulation of the width of the annular gap takes place over a certain bandwidth.

Conventional annular gaps in such atomizing nozzles have a width of 0.1 to about 0.25 mm, and it is desirable to have the capability of expelling 1 to 5 grams of medium to be sprayed per millimeter of length of the gap.

Depending on the nature of the medium to be sprayed, then, the axial moveability makes it possible for the gap height to be set automatically. When a specific medium with a specific pressure is led through the first flow channel, intrinsic properties, for example, in the case of a liquid, its viscosity and, in the case of emulsions, their flowability and stickiness, exert a considerable influence. on what quantity per millimeter of length of the gap can pass through. In other words, there are liquids which can be expelled relatively simply through such a gap, whereas others require a somewhat wider gap for the same outflow quantity.

It was found, in practical use, that, of course within a certain determined range, the gap width is set automatically to an optimum value in the case of given boundary conditions, that is to say the nozzle virtually regulates itself.

The initially mentioned possibility of closing the nozzle mouth of the first flow channel in the state of rest can be achieved in a simple way, for example in the case of an upright nozzle, in that the at least one moveable wall sinks due to gravity and the closing movement thereby takes place.

In the case of angled, horizontal or even suspended nozzles, this movement may take place by means of a spring force or other mechanisms.

In a further embodiment of the invention, conveying elements, which control a movement of the medium to be atomized which is transported to the nozzle orifice, are arranged at least on one of the walls rotatable relative to one another.

The provision of these conveying elements has the considerable advantage that, by virtue of the conveying elements, the toroidal movement formed by the axial transport direction and by the rotating walls is, on the one hand, guided in a focused manner and also additionally promoted.

In addition, these conveying elements may also serve as mechanical means for transporting in a focused manner and, if necessary, comminuting any entrained solid lumps.

In a embodiment of the invention, one wall is designed to be stationary and the other wall to be rotatable.

This measure has the advantage in structural terms that only one of the two walls has to be moved, and, accordingly, corresponding drive members have to be present for only one of these walls.

In a further embodiment of the invention, one wall is stationary and the other wall is axially displaceable.

This, too, results again in the advantage of the simple structural configuration of the additional axial displaceability of the walls relative to one another.

In a further embodiment, that wall which is rotatable is also at the same time axially displaceable.

This measure has the advantage in structural terms that the measures both of rotatability and of axial displaceability can be implemented in connection with a single wall.

In a further embodiment of the invention, the control of the axial displaceability is carried out by means of the conveyed medium to be atomized itself.

This measure makes it possible to have the already abovementioned self-regulating effect of the gap width of the nozzle orifice of the first flow channel.

In a further embodiment of the invention, the axial displaceability is designed in such a way that, in the state of rest, the nozzle orifice of the first flow channel is closed.

This measure makes it possible, in an extremely simple way in structural terms, to have the initially mentioned closing of the nozzle orifice of the first flow channel, this taking place exactly when no medium to be atomized is led through the first flow channel.

In a further embodiment of the invention, the axial displaceability takes place counter to a return force which moves the displaceable wall or displaceable walls into the closing position of the nozzle orifice.

As already mentioned, gravity may be utilized as the return force, so that, in the case of upright nozzles, the one moveable wall is moved into the closing position due to gravity as a result of displacement relative to the other.

If gravity is not sufficient or not capable of executing this movement, this may take place by means of other control elements, for example by means of springs or other elements.

In a further embodiment of the invention, the axial displaceability of the walls is designed in such a way that, in the state of rest, the nozzle orifice of the second flow channel is also closed.

This measure has the advantage that both nozzle orifices are closed in the state of rest.

This not only has the already mentioned advantage that no dirt can enter the nozzle, but also has the advantage that residual medium quantities possibly still present in the flow channels do not emerge, so that, for example during transport or demounting, such residual quantities then do not emerge and cause soiling.

In a further embodiment of the invention, the rotatable wall carries, on the outside of a head of an atomizing nozzle, a fan, by means of which the head can be freed of any adherent substances in the region of the nozzle orifice.

A problem which repeatedly arises is the soiling of the mouth head due to an usually uncontrolled secondary air movement which occurs in the region surrounding the liquid gap or spray gap. Owing to the high blow-out velocity, vacuum regions are formed which re-attract stray liquid droplets just sprayed and deposit them on the mouth head. This consequently then results there in an agglomeration or a gradual build-up of dried-on solids from the sprayed liquid.

The provision of the fan in this case makes it possible to keep these critical regions free of such adherent substances. The rotatability according to the invention of the wall therefore can not only be utilized to provide optimum conditions inside the nozzle, but this rotating movement can at the same time be utilized to prevent substances from adhering to the outside of the head.

In a preferred embodiment of the invention, one wall is designed as the outside of a central spindle which is rotatable.

This measure has the structural advantage that the rotating wall is produced by a structurally simple means, to be precise the central spindle.

In a further embodiment of the invention, the conveying elements are designed as rotor portions.

This measure has the advantage that an especially uniform promotion of the movement of the medium to be sprayed is thereby possible.

If the rotor portions are formed on the outside of the above-mentioned central spindle, this is extremely simple to implement in structural terms and especially favourable and focused conveyance can be achieved. The length and number of the rotor portions, that is to say the number of conveying wheels and their cross-sectional shape, may additionally be varied, so that particularly difficult media to be sprayed can additionally be dealt with.

In a further embodiment of the invention, the spindle is driven via a pneumatically operable motor.

This measure has the advantage in structural terms that a gaseous medium for spraying the medium to be sprayed is led through such a spraying nozzle in any case, that is to say the latter is connected to a source of spray air, usually compressed air. Parts of this air may therefore also be utilized at the same time for operating the motor which ensures the rotary movement between the walls.

In a further preferred embodiment, the spindle is plugged onto a drive journal which allows some axial moveability of the spindle.

This measure has the particular advantage in structural terms that, as a result of these dimensions, the spindle is both rotatable and to some extent axially moveable.

The degree of moveability may be limited, for example, by means of a connecting crosspin which runs in a long hole in the drive journal.

In a further preferred embodiment of the invention, the fan is seated on the head of the spindle.

The advantage of this measure is that this advantageous design is at the same time also implemented on the central spindle.

It goes without saying that the features mentioned above and those yet to be explained below can be used not only in the combinations specified, but also in other combinations or alone, without departing from the scope of the invention.

### BRIEF DESCRIPTION OF THE DRAWINGS

The invention is described and explained in more detail below with reference to some selected exemplary embodiments, in conjunction with the accompanying drawings in which:

FIG. 1 shows, partially in longitudinal section, a side view of a first embodiment of an atomizing nozzle according to the invention,

FIG. 1a shows an enlarged view of the region circumscribed by a circle at top right in FIG. 1,

FIG. 2 shows a side view, rotated through 90°, of the atomizing nozzle of FIG. 1,

FIG. 3 shows an illustration corresponding to the sectional illustration of FIG. 1, of a further embodiment of an atomizing nozzle with a fan attached to the head, and

FIG. 4 shows a top view of the end face of the head of the atomizing nozzle of FIG. 3.

### DETAILED DESCRIPTION OF PREFERRED EMBODIMENTS

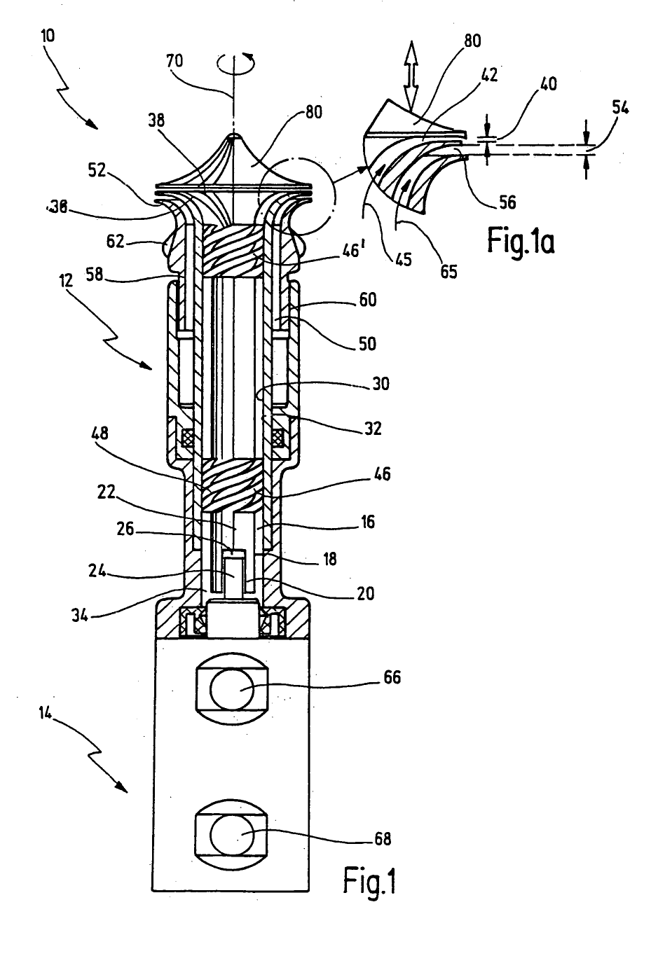

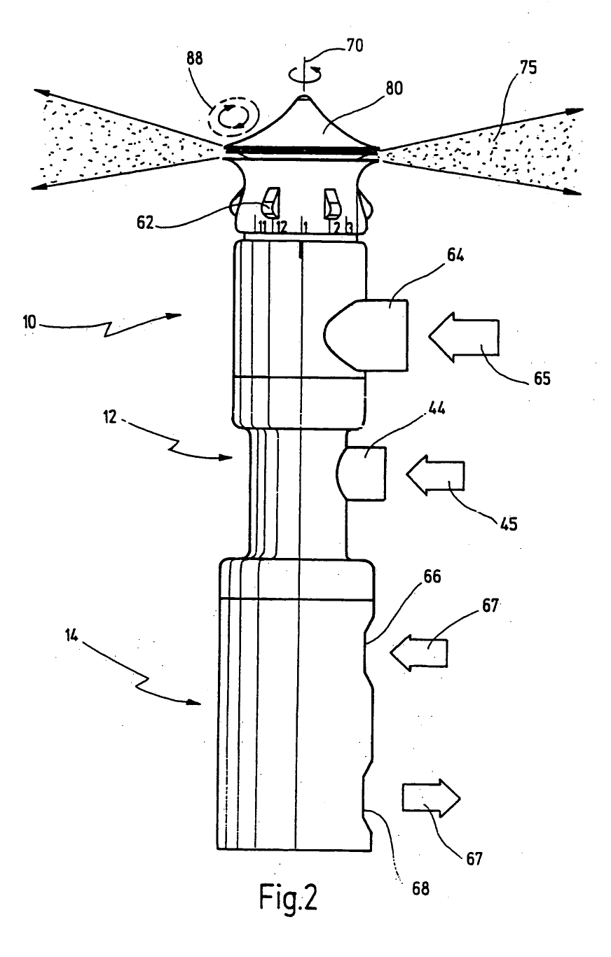

An atomizing nozzle illustrated in FIGS. 1 and 2 is designated as a whole by the reference numeral 10.

The atomizing nozzle 10 has an approximately bar-shaped nozzle body 12, to one end of which, the lower end in the illustration of FIGS. 1 and 2, a motor 14 is flanged.

A first flow channel 16 which is annular or takes the form of an annular gap is formed in the nozzle body 12.

This first flow channel 16 is delimited on the inside by an inner wall 18 which is the outside 20 of a central spindle 22.

The spindle 22 is plugged onto an upright angular drive journal 24 of the motor 14 and, for this purpose, has at its lower end a corresponding slot 26.

As a result, on the one hand, a rotationally fixed connection between the motor 14 and the spindle 22 is afforded, that is to say, when the motor 14 is in operation, the spindle 22 rotates about its longitudinal mid-axis 70 which is also at the same time the longitudinal mid-axis of the atomizing nozzle 10.

The plug connection is, moreover, such that some axial moveability of the spindle 22 is afforded, the meaning and purpose of this being described later in connection with the type of operation.

The axial displaceability or the limitation of the amount of axial movement can be provided in that the drive journal has cut out in it a vertical long hole which receives a crosspin which is inserted in the radial bore of the spindle 22 in the region of the slot 26.

The first flow channel 16 is delimited on the outside by an outer wall 30 which is formed by an inside of a continuous central bore or orifice 34 in the nozzle body 12. Both the spindle 22 and the nozzle body 12 widen, opposite the motor 14, in a trumpet-like manner in a widening 36 and a widening 38 respectively, as is evident especially also from FIG. 1a.

An approximately horizontally oriented nozzle orifice 40 in the form of an annular gap 42 running around through 360° is therefore formed.

The width of the annular gap 42 can be varied on account of the axial displaceability of the spindle 22, the variation being in the range of between 0.1 mm and 0.25 mm.

As is evident especially from FIG. 2, the first flow channel 16 is connected to a lateral connection piece 44, so that, via this connection piece 44, a medium to be atomized, for example a liquid 45, can be fed into the first flow channel 16, can be transported through the first flow channel 16 and can emerge via the annular gap 42. The transport and conveyance of this liquid 45 is also additionally promoted by conveying elements 48 in the form of two rotor portions 46 and 46′ on the outside 22 of the spindle 22, the height of a rotor being such that the latter corresponds approximately to the gap width of the first flow channel 16 inside the atomizing nozzle 10.

In the shown embodiment, the profile of the rotor 46 is such the latter bears approximately over its area against the inside 32 of the central orifice 34, other profiles, for example rounded or pointed rotor profiles, of course, also being possible.

In order to atomize finely the liquid or the medium to be atomized, which may also be a powder, which emerges through the annular gap 42, a second flow channel 50 is provided.

This second flow channel 50 encircles the first inner flow channel 16 and opens into a codirectional widening 52 in a nozzle orifice 54 which is likewise in the form of an annular gap 56. The annular gap 56 is arranged in such a way that it is directly adjacent to the annular gap 42, directly below the first annular gap 42 in the shown embodiment of the upright atomizing nozzle 10. The second flow channel 50 is delimited on the inside by the nozzle body 12 and on its outside by a rotatable sleeve 58. The sleeve 58 is screwed into the nozzle body 12 via a thread 60.

As is evident especially from FIG. 2, the sleeve 58 is provided on its outside with a scaling 62.

Consequently, by the sleeve 58 being rotated, the gap width of the annular gap 54 can be varied.

The second flow channel 52 is connected to the exterior via a radially projecting connection piece 64, via which a gaseous medium in the form of spray air 65 is introduced into the nozzle body 12.

The motor 14 is designed as a pneumatically operated motor, that is to say compressed air 67 is introduced through an inlet 66 and this compressed air 67 is discharged again through an outlet 68.

During operation, the motor 14 is controlled and driven by the abovementioned compressed air, so that the spindle 22 rotates. The rotational speed is governed by the respective application of the medium to be sprayed and may be in the range of 1 to 1 000 revolutions per minute. A medium to be sprayed, for example a tacky liquid to be sprayed for granulation, is conveyed by the connection piece 44 and is expressed via the annular gap 42. The liquid may also consist of an externally melted substance.

This expressed liquid is sprayed in a fine mist by means of the spray air 65 emerging from the second flow channel 50 or from the nozzle orifice 54 of the latter, the spray air usually being under a pressure of 0.5 to 5.0 bar.

This gives rise to a correspondingly horizontally oriented spray pat or corresponding spray cone, as indicated by the reference numeral 75 in FIG. 2.

As mentioned, the gap width of the annular gap 56 from which the spray air emerges can be varied by means of the rotatable sleeve 58.

The gap width of the annular gap 42 from which the liquid 45 to be sprayed emerges is regulated automatically owing to the axial moveability of the spindle 22, on the one hand by means of the predetermined liquid pressure of the liquid to be sprayed and additionally, to some extent, by virtue of the intrinsic properties of the liquid, that is to say its viscosity or its nature as an emulsion, slurry or powder mixture.

If, as shown in FIG. 1, the atomizing nozzle 10 is designed as an upright nozzle and medium to be sprayed is no longer supplied, the spindle 22 sinks down due to gravity and at the same time automatically closes the annular gap 42 or the first flow channel 46, as indicated in FIG. 1a by the double arrow.

It may be gathered from FIG. 1 that the spindle 22 is closed off on its outside via an approximately mushroom-shaped head 80.

In practical use, it was found, as indicated in FIG. 2, that, in a region 88 of the outer edge of the head 80, certain problem zones exist, in which sprayed particles or even solid particles whirling around in a fluidized-bed device gradually settle. This region is indicated in FIG. 2 by the reference numeral 88.

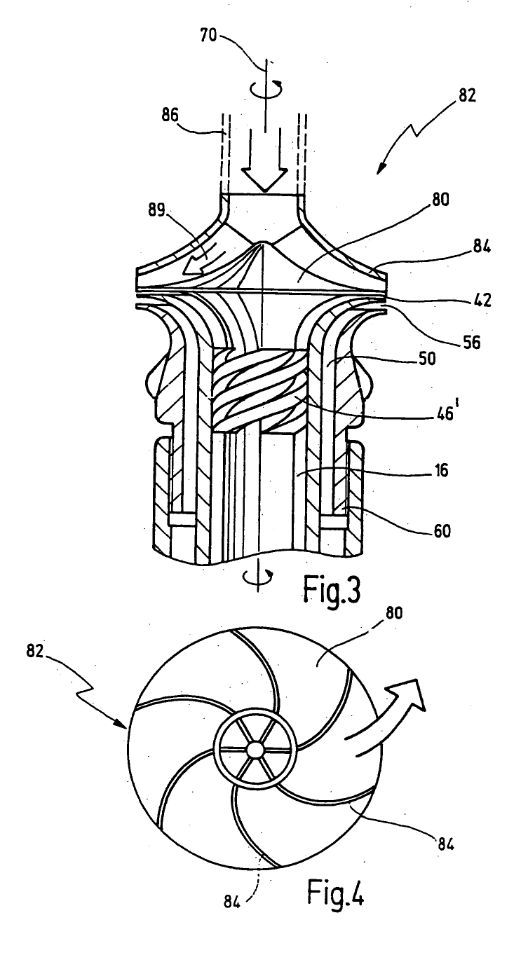

FIGS. 3 and 4 illustrate a design variant which, as regards the configuration of the atomizing nozzle as such, is identical to the embodiment described in connection with FIGS. 1 and 2.

A fan 82 is additionally mounted on the outer topside of the head 80.

This fan 82 has a plurality of rearwardly curved centrifugal fan blades 84 which suck in air out of an axial tube 86 and, as is evident especially in the top view of FIG. 4 from the arrow 89, blow out this air radially. As a result, the critical region designated by the reference numeral 88 in FIG. 2 is continuously blown free, so that no undesirable adherences or accumulations of solid or liquid particles occur.

This air additionally blown out by the fan 82 may additionally be utilized to accompany the spray cone 75, illustrated in FIG. 2, on its top side, that is to say either to control this, additionally swirl it or utilize it for other purposes.

Depending on where the air sucked in by the axial tube 86 originates, this air may also be utilized as a “microclimate”, for example in the form of hot air, in order to keep the liquid droplets supplied as a melt as long as possible in the melted state, so that those particles which are to be sprayed by the spray nozzle are coated with still liquid particles even at some distance from the nozzle.

In the embodiment described above, one wall, to be precise the outer wall 30, of the first flow channel 16 was stationary, and the inner wall 18, to be precise the outside 20 of the spindle 22, was rotatable.

It is also conceivable for this to be carried out kinematically in reverse or else, if appropriate, for both walls to be set in rotational movement.

1. An atomizing nozzle, comprising
a first flow channel of annular cross section for guiding a medium to be atomized, said first flow channel being circumscribed by two walls spaced radially apart from one another, said first flow channel opens into an annular nozzle orifice, and
a second flow channel for guiding a gaseous spray medium, which second flow channel encircles the first flow channel, said second flow channel likewise opens into an annular nozzle orifice,
wherein said two walls circumscribing said first flow channel are rotatable relative to one another about a nozzle longitudinal axis.

2. The atomizing nozzle of claim 1, wherein said two walls are also axially displaceable relative to one another, whereby, a gap width of the nozzle orifice of said first flow channel can be varied.

3. The atomizing nozzle of claim 2, wherein one of said two walls is axially displaceable.

4. The atomizing nozzle of claim 1, wherein conveying elements are arranged on at least one of said two walls rotatable relative to one another, and extending into said first flow channel, said conveying elements control a movement of said medium to be atomized which is transported to said nozzle orifice of said first flow channel.

5. The atomizing nozzle of claim 1, wherein one of said two walls is stationary, and another one of said two walls is designed rotatable.

6. The atomizing nozzle of claim 1, wherein one of said two walls is stationary and the other one of said walls is rotatable and at the same time axially displaceable.

7. The atomizing nozzle of claim 1, wherein said two walls are also axially displaceable relative to one another and a control of said axial displaceability takes place by means of said conveyed medium in said first flow channel to be atomized.

8. The atomizing nozzle of claim 1, wherein said two walls are also axially displaceable relative to one another, so that the gap width of the nozzle orifice can be varied, and wherein said axial displaceability is designed in such a way that, in a state of rest, said nozzle orifice of said first flow channel is closed.

9. The atomizing nozzle of claim 8, wherein said axial displaceability is designed in such a way, that, in said state of rest, said nozzle orifice of said second flow channel is also closed.

10. The atomizing nozzle of claim 1, wherein said two walls are also axially displaceable relative to one another, so that the gap width of the nozzle orifice of the first channel can be varied, and wherein said axial displaceability takes place counter to a return force of a spring, which moves said displaceable one wall or said two displaceable walls into a closing position of the nozzle orifice of said first flow channel.

11. The atomizing nozzle of claim 1, wherein one of said two walls is rotatable, which rotatable wall carries, on a topside of a head of said atomizing nozzle a fan, by means of which fan said head can be freed from any adherent substances in an area of the said nozzle orifices of said first flow channel and said second flow channel.

12. The atomizing nozzle of claim 11, wherein said fan is seated on a central spindle and an outer side of said spindle provides said rotatable wall.

13. The atomizing nozzle of claim 1, wherein one of said two walls is designed as an outside of a central spindle which is rotatable.

14. The atomizing nozzle of claim 13, wherein said spindle is driven by a pneumatically operable motor.

15. The atomizing nozzle of claim 14, wherein said spindle is plugged on a drive journal of said motor, said drive journal allowing some axial displaceability of said spindle.

16. The atomizing nozzle of claim 4, wherein said conveying elements are designed as rotor portions.
